(19) United States
(12) Patent Application Publication
(10) Pub. No.: US 2011/0287764 A1
(43) Pub. Date: Nov. 24, 2011

(54) HOME LOCATION REGISTER QUERY REDUCTION APPARATUS AND METHODS

(75) Inventor: Stephen J. Zitnik, Fort Meyers, FL (US)

(73) Assignee: Interop Technologies, Fort Meyers, FL (US)

(21) Appl. No.: 13/112,466

(22) Filed: May 20, 2011

Related U.S. Application Data
(60) Provisional application No. 61/347,139, filed on May 21, 2010.

(51) Int. Cl. H04W 4/00

(52) U.S. Cl. 455/433

(57) ABSTRACT

Methods and apparatus for reducing the traffic volume associated with home location register queries used to determine a subscriber's location in a wireless telecommunications network or in an IP multimedia subsystem network. A query reduction mechanism (QRM) is in communication with a short message service center (SMSC) and with a home location register (HLR) to provide a destination location to send an incoming message. The SMSC sends a lookup query to the QRM and the QRM sends a location response back to the SMSC. The destination location and the message are then sent to the mobile switching center for transmission of the message to the destination mobile device. The QRM includes a route cache with location information, route caching logic, and a passive monitor to receive subscriber location updates.

### CROSS-REFERENCE TO RELATED APPLICATION

This patent application claims the benefit of U.S. provisional patent application Ser. No. 61/347,139, filed on May 21, 2010.

### FIELD OF THE INVENTION

The present invention relates generally to methods and apparatus for reducing the traffic volume associated with home location register (HLR) queries used to determine subscribers' locations in traditional wireless telecommunications networks. This invention also reduces queries to a home subscriber server (HSS) in an IP multimedia subsystem (IMS) based network.

### BACKGROUND OF THE INVENTION

At the time a subscriber number is provisioned on a mobile network, the number is populated in a home location register (HLR) by the provisioning system. The HLR is a network element which maintains and shares the current locations of mobile subscribers in order to ensure proper routing of voice and text messaging, or short messaging (SMS), traffic within a wireless telecommunications network.

It is possible to have multiple HLRs on a single network, but each subscriber number will only reside in a single, dedicated HLR. At provisioning time, the subscriber number is also populated in the short message service center (SMSC) to enable SMS service along with the address of the aforementioned HLR so the SMSC knows which HLR to query when attempting to locate the subscriber.

For each text message sent to a mobile device, the SMSC looks up the destination mobile number internally, determines the associated HLR address and queries the HLR to determine the location of the destination subscriber.

An object of the present invention is to utilize a query reduction mechanism (QRM) to reduce the traffic volume associated with home location register (HLR) queries in determining subscribers' locations in traditional wireless telecommunications networks, thereby enhancing the speed and efficiency of the network.

A further object of the present invention is to utilize a query reduction mechanism (QRM) to reduce traffic volume to a home subscriber server (HSS) in an IP multimedia subsystem (IMS) based network, thereby enhancing the speed and efficiency of the network.

### SUMMARY OF THE INVENTION

The present invention is directed to methods for reducing the traffic volume associated with home location register queries used to determine a subscriber's location in a wireless telecommunications network. The network includes a short message service center, a home location register and a mobile switching center. The first method includes the steps of providing a query reduction mechanism, the query reduction mechanism being in communication with the short message service center and with the home location register, providing the query reduction mechanism with the location information relating to a plurality of subscribers to the network, receiving an incoming message from a subscriber's mobile device at the short message service center, sending a lookup query from the short message service center to the query reduction mechanism to determine a destination location for sending the incoming message to a destination mobile device, sending a response to the lookup query from the query reduction mechanism to the short message service center with the destination location for the message, and delivering the message and the destination location of the message to the mobile switching center for transmission of the message to the destination mobile device.

In another method, the query reduction mechanism includes route caching logic and a route cache for storing the address information of the plurality of subscribers. This method includes the steps of receiving the lookup query from the short message service center at the route caching logic of the query reduction mechanism, using the route caching logic to query the route cache to determine a destination location for sending the incoming message to a destination mobile device, and if a corresponding cache entry is found, providing the destination location from the route cache to the route caching logic, and sending a response to the lookup query from the route caching logic to the short message service center with the destination location for the message.

If a corresponding cache entry is not found in the route cache for a destination location request, a further method includes the steps of sending a lookup query from the route caching logic to the home location register to determine a destination location for the incoming message, receiving a response to the lookup query from the home location register at the route caching logic, and if the response from the home location register includes a destination location for the message, sending a response to the lookup query from the route caching logic to the short message service center with the destination location for the message. If the response from the home location register does not include a destination location for the message; the step includes sending a response to the lookup query from the route caching logic to the short message service center that the destination location for the message cannot be found.

In accordance with additional methods, steps include periodically updating the location information relating to a plurality of subscribers to the network in the query reduction mechanism with information at a subscriber provisioning system, time stamping the location information relating to the plurality of subscribers at the time that the location information is provided to the query reduction mechanism, permitting the location information relating to any subscriber to expire upon the passage of a predetermined amount of time from the time that the location information is provided to the query reduction mechanism, and updating the location information in query reduction mechanism relating to any subscriber upon receipt of new information that the subscriber's location or status has changed. Where the query reduction mechanism includes a passive monitor, the method may include the steps of receiving updated subscriber location information at the passive monitor, and providing the updated subscriber location information to the route cache for storage.

Similar and related methods may be employed in an IP multimedia subsystem (IMS) network. In this embodiment, the query reduction mechanism communicates with a short message service center, a home subscriber server, and a call session control function to achieve similar results and efficiencies in retrieving subscriber destination locations for incoming messages. Overall, the operation of the IMS network is analogous to that described above for the wireless telecommunications network.

The present invention is further directed to apparatus which utilizes a query reduction mechanism. For example, a wireless telecommunications network may include a short message service center for receiving an incoming message from a subscriber's mobile device, a home location register, a mobile switching center, and a query reduction mechanism, with the query reduction mechanism in communication with the short message service center and with the home location register; and the query reduction mechanism containing location information relating to a plurality of subscribers to the network. Upon receipt of an incoming message, the short message service center sends a lookup query to the query reduction mechanism to determine a destination location for sending the incoming message to a destination mobile device, the query reduction mechanism responds to the lookup query by sending the destination location for the message to the short message service center, and the short message service center delivers the message and the destination location to the mobile switching center for transmission of the message to the destination mobile device. The query reduction mechanism may include a subscriber provisioning system for periodically updating the location information in the query reduction mechanism relating to the plurality of subscribers to the network.

The query reduction mechanism may further include route caching logic, and a route cache for storing the address information of the plurality of subscribers, the route caching logic receives the lookup query from the short message service center, and the route caching logic queries the route cache to determine a destination location for sending the incoming message to a destination mobile device. If a corresponding cache entry is found, the route caching logic provides the destination location from the route cache to the short message service center.

If a corresponding cache entry cannot be found in the route cache, the route caching logic sends a lookup query to the home location register to determine a destination location for the incoming message, and the home location register sends a response to the lookup query to the route caching logic. If the response from the home location register includes a destination location for the message, the route caching logic sends a response to the short message service center with the destination location for the message, and if the response from the home location register does not include a destination location for the message; the route caching logic sends a response to the short message service center that the destination location for the message cannot be found.

The wireless telecommunications network may further include a passive monitor associated with the query reduction mechanism for receiving updated subscriber location information and for providing the updated subscriber location information to the route cache for storage therein.

Similar and related apparatus may be employed in an IP multimedia subsystem (IMS) network. In this embodiment, the query reduction mechanism communicates with a short message service center, a home subscriber server, and a call session control function to achieve similar results and efficiencies in retrieving subscriber destination locations for incoming messages.

### BRIEF DESCRIPTION OF THE DRAWINGS

The invention, together with its objects and the advantages thereof, may best be understood by reference to the following description taken in conjunction with the accompanying drawings, in which like reference numerals identify like elements in the figures, and in which:

FIG. 1 is a diagrammatic view which illustrates the delivery flow of typical mobile terminated text messages in a traditional prior art wireless telecommunications network;

FIG. 2 is diagrammatic view which illustrates the delivery flow of typical mobile terminated text messages in a prior art IP multimedia subsystem network;

FIG. 3 is a diagrammatic view which illustrates the delivery flow of typical mobile terminated text messages by using a query reduction mechanism with cache hit in accordance with a the present invention;

FIG. 4 is a diagrammatic view which illustrates the delivery flow of typical mobile terminated text messages by using a query reduction mechanism, similar to FIG. 3 but without cache hit, in accordance with another aspect of the present invention;

FIG. 5 is a diagrammatic view which illustrates the delivery flow of typical mobile terminated text messages by using a query reduction mechanism with cache hit in an IP multimedia subsystem network in accordance with yet another aspect of the present invention: and

FIG. 6 is a diagrammatic view which illustrates the delivery flow of typical mobile terminated text messages by using a query reduction mechanism, similar to FIG. 5 but without cache hit, in an IP multimedia subsystem network in accordance with a further aspect of the present invention

### DESCRIPTION OF THE PREFERRED EMBODIMENTS

It will be understood that the present invention may be embodied in other specific forms without departing from the spirit thereof. The present examples and embodiments, therefore, are to be considered in all respects as illustrative and not restrictive, and the invention is not to be limited to the details presented herein.

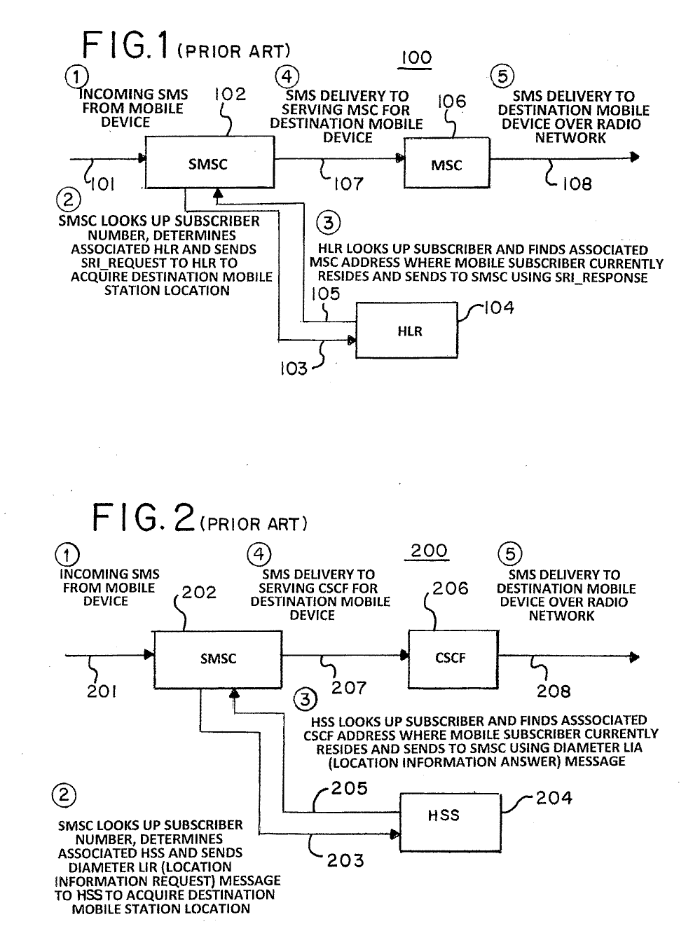

FIG. 1 illustrates a portion 100 of a traditional wireless telecommunications network, which is prior art to the present invention. This network portion 100 includes a plurality of interconnected elements, such as a short message service center (SMSC) 102, a home location register (HLR) 104 and a mobile switching center (MSC) 106.

At the time a subscriber number is provisioned on a mobile network, the subscriber's number is populated in the HLR 104 by the provisioning system. The HLR is a network element which maintains and shares the current locations of mobile subscribers in order to ensure proper routing of voice and text messaging, or short messaging (SMS) traffic within a wireless telecommunications network. It is possible to have multiple HLRs 104 on a single network, but each subscriber number will only reside in a single, dedicated HLR. At provisioning time, the subscriber number is also populated in the short message service center (SMSC) 102 to enable SMS service along with the address of the aforementioned HLR 104 so the SMSC knows which HLR to query when attempting to locate the subscriber.

For each text message sent to a mobile device and received at an input 101, the SMSC 102 looks up the destination mobile number internally, determines the associated HLR address and queries the HLR 104, such as via line 103, to determine the location of the destination subscriber. In GSM networks, this query is referred to as a Send Routing Information Request, or an SRI_Request. The corresponding response from the HLR is referred to as an SRI_Response. The request and response in code division multiple access (CDMA) networks are the referred to as an SMS_Request and an SMS_Response, respectively. For the purpose of simplicity, the GSM terminology will be used throughout this disclosure. However, the concepts apply equally to both network technologies and the operation is generally the same.

The HLR 104 responds to the SMSC 102 with the subscriber's current status and location using the SRI_Response, such as via line 105. Location is provided in the form of a mobile switching center (MSC) 106 address, which is used by the SMSC 102 for routing the actual text message to the appropriate MSC, via line 107, over the Signaling System 7 (SS7) network. From there, the MSC 106 is able to deliver the message via line 108 to the subscriber's mobile device over a radio access network. This process of an SMSC 102 querying an HLR 104, getting a response with location information, and forwarding the message based on that location information is repeated for every mobile terminated (MT) SMS message.

When a sample population of Short Message Service (SMS) data is analyzed, it becomes evident that SMS traffic is conversational, meaning that several consecutive text messages are normally sent and received between the same two mobile stations. Secondly, most SMS users, even though mobile, are generally stationary relative to the serving MSC 106 over the course of a conversation. In these scenarios, the location information provided from subsequent HLR queries is exactly the same.

FIG. 2 illustrates a portion 200 of an Internet Protocol (IP) multimedia subsystem (IMS) network, which is also prior art to the present invention. This network portion 200 includes a plurality of interconnected elements, such as a short message service center (SMSC) 202, a home subscriber server (HSS) 204 and a call session control function (CSCF) 206.

Similar query mechanism and flows can be applied in an IMS network 200 environment. The IMS environment can be considered analogous to the previous network 100 description from a logical point of view. However, the predominant transport protocol is Internet Protocol (IP) rather than SS7. In addition, the network element nomenclature is different. The HLR function is provided by the Home Subscriber Server (HSS) 204, the role of the Mobile Switching center is performed by the Call Session Control Function (CSCF) 206 and the HSS requests/responses are performed using the Diameter protocol-based Location Information Request (LIR) via a line 203 and Location Information Answer (LIA) via a line 204.

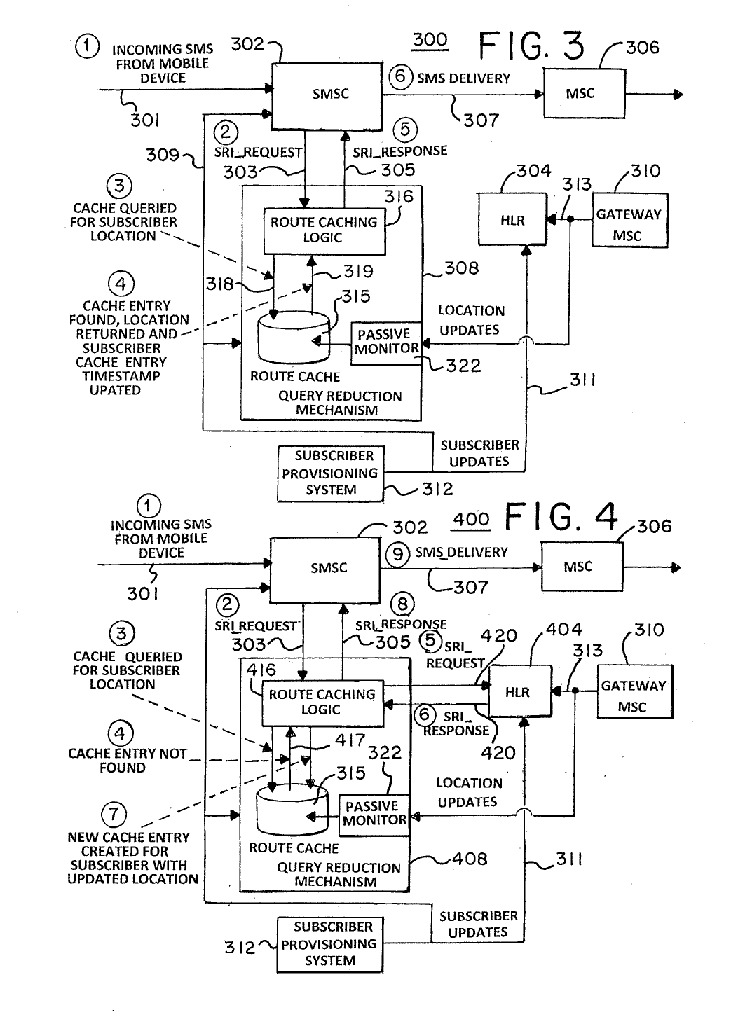

FIG. 3 illustrates a portion 300 of a wireless telecommunications network, in accordance with the present invention. This network portion 300 includes a plurality of interconnected elements, such as a short message service center (SMSC) 302, a home location register (HLR) 304, a mobile switching center (MSC) 306, a query reduction mechanism 308, a gateway MSC 310. A subscriber provisioning system 312 provides subscriber address and/or number information to the SMSC 302, to the HLR 304 and to the QRM 308.

FIG. 3 also illustrates the delivery flow of typical mobile terminated text messages by using the query reduction mechanism (QRM) 308. The QRM 308 is a network element which resides between the SMSC 302 and the HLR 304, and acts like the HLR to provide routing locations for subscribers to the SMSC 302. The QRM 308 has network connectivity to the HLR 304, giving it the ability to query the HLR when up-to-date location information is required.

Given the generally static location of subscribers relative to their serving MSC 306 in a wireless telecommunications network, a primary method used in the HLR Query Reduction Mechanism (QRM) 308 is route caching. Caching the destination mobile station's location, in other words, saving the destination MSC address in memory or in a database 315, and reusing it on subsequent message deliveries to the same subscriber rather than re-querying the HLR, can increase network efficiency dramatically. However, in order to maximize effectiveness (or cache hit rate), the cache must be kept as accurate (or up to date) as possible. The cache can be kept accurate by three means. The first is an HLR sourced update which consists of an HLR initiated message to other network elements (like the QRM) in order to indicate a subscriber location or status change. The second means is a timeout which expires each cache entry after a predetermined period of time. This period of time can be varied and optimized depending on the typical movement behaviors of subscribers for a particular network. The third is to observe the movement of subscribers on the network through passive monitoring at the same network node where the HLR 304 receives its location updates from the network. When a subscriber moves from their last known location, the previous cache entry associated with the subscriber can be invalidated and replaced with their new location, i.e., a new MSC address thus keeping the QRM subscriber location entries synchronized with the HLR 304.

When a subscriber is first provisioned on the network, their Mobile Subscriber ISDN Number (MSISDN) is setup in the HLR 304 by the subscriber provisioning system 312. Typically, the specific HLR/subscriber pair will be associated indefinitely. In other words, subscribers do not move from HLR to HLR unless some network changes are being implemented. If SMS service is included in the subscriber's plan, their number will also be provisioned within the SMSC 302 along with the appropriate HLR address to be queried for location when a message is to be delivered. With a QRM 308 in place, the HLR address in the SMSC 302 will correspond to the QRM address, since all HLR queries from the SMSC will be directed to the QRM 308. The QRM 308 will also be provisioned with the subscriber number and the actual HLR address at which the subscriber resides.

Upon receiving an SMS on input line 301 to be delivered, the SMSC 302 conducts an internal lookup to determine the address of the HLR, such as 304, to query for the destination device's location. Since the network is utilizing the QRM 308, the lookup query (SRI_Request) from the SMSC will be directed to the QRM on line 303. The QRM will check its cache 315 for the location of the subscriber. If the subscriber is located in the cache 315, the MSC address associated with the cache entry will be returned to the SMSC using the SRI_Response on line 305 and the SMSC 302 will attempt delivery.

The effectiveness of the QRM 308 is driven by the combination of cache hit rate and cache accuracy. For that reason, it is critical that the cache entries be kept as fresh as possible. The four different methods which may be utilized to keep the cached location updated are described below.

1) HLR sourced update—Some HLRs may be configured with a feature that proactively notifies other network elements when a subscriber location or status changes. In this case, the QRM cache entry for the subscriber would be updated with the applicable changes.

2) The cache entry expires—Each location update that is written to the cache is time stamped upon entry and assigned a time-to-live (TTL). The TTL is a configurable value in the QRM 308 and should be tuned based on subscribers' behavior on a specific network in order maximize the effectiveness of the cache. If the TTL expires, the cache entry is assumed to be invalid and the cache entry is removed.

Operation of the network portion 300 when a cache entry has expired or is missing is shown in the network portion 400 of FIG. 4. When no cache entry can be found, the next SRI_Request from the SMSC 302 to the QRM 308 will look in the cache for an entry and none will be found for the corresponding destination number, resulting in a cache “miss”. Without a valid cache entry, the QRM 408 will send an SRI_Request 420 via the route caching logic 416 and a line 420 to the HLR 404 to get the most up-to-date location information. In this case, upon receiving the request, the HLR 404 will look up the subscriber number and return the MSC address associated with the subscriber's current location to the QRM 408 using an SRI_Response via a line 421. The QRM 408 will cache this entry containing the subscriber number/location information (with associated time stamp) and return the MSC address to the SMSC 402 as an SRI_Response via a line 305. The SMSC 302 then uses the MSC address information to attempt delivery.

3) Passive Monitoring port—The QRM 308 or 408 can be enabled with a passive monitoring port 322 that unintrusively monitors all location updates destined for the HLR 304 or 404 (from the network via the Gateway MSC 310). These updates are sent via SS7 using the MAP_UPDATE_LOCATION message. If an updated location is detected based on this method, the cache entry is updated with the new location.

The passive monitoring is not necessary if the optional HLR feature described in method 1 is employed since each mechanism, while different in flow, serves the same purpose. Utilizing this passive monitoring option requires the use of an additional SS7 or SIGTRAN interface into the network. This interface “listens” to all traffic between the Gateway MSC (GMSC) 310 and the HLR 304 or 404 and the QRM device 308 or 408 specifically filters for location update information in the form of MAP_UPDATE_LOCATION messages. If SS7 is used, a passive monitoring access point on the TDM interface between the GMSC 310 and HLR 308 or 408 must be tapped. If SIGTRAN is employed, the access is typically through a mirrored port on the switch that is responsible for the transport of the data traffic between the GMSC and the HLR.

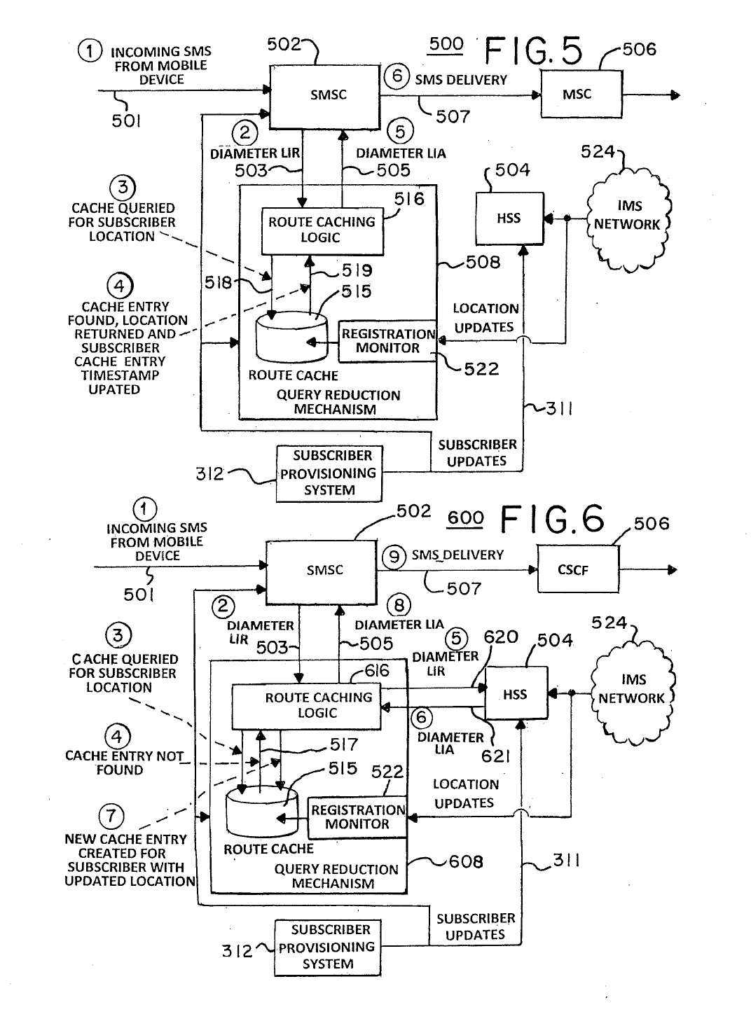

In accordance with a further aspect of the present invention, FIGS. 5 and 6 illustrate network portions 500 and 600, respectively, for an Internet Protocol (IP) multimedia subsystem (IMS) network which includes the delivery flow of typical mobile terminated text messages by using a query reduction mechanism (QRM) 508 or 608. These network portions 500 and 600 include a plurality of interconnected elements, such as a short message service center (SMSC) 502, a home subscriber server (HSS) 504, a call session control function (CSCF) 506, and a query reduction mechanism 508 or 608. A subscriber provisioning system 312 provides subscriber address and/or number information to the SMSC 502, to the HSS 504 and to the QRM 508 or 608.

As will be appreciated by those skilled in the art, the IMS networks 500 and 600 and the QRM 508 or 608 perform similar functions as the corresponding elements in the networks 300 and 400 in FIGS. 3 and 4, respectively, but interface with a different set of network elements and use a different set of protocols. All flows remain the same and are shown in FIGS. 5 and 6 using IMS based nomenclature. One notable difference is that the passive monitor 322 described in the non-IMS network is replaced by a registration monitor 522 inherent in the IMS. In a similar fashion to the description for networks 300 and 400, above, the QRM 508 or 608 can be notified by multiple network elements in the IMS network 500 or 600 that a user location has changed.

While particular embodiments of the invention have been shown and described, it will be obvious to those skilled in the art that changes and modifications may be made therein without departing from the invention in its broader aspects.

1. A method for reducing the traffic volume associated with home location register queries used to determine a subscriber's location in a wireless telecommunications network, said network including a short message service center, a home location register and a mobile switching center, said method comprising the steps of:
providing a query reduction mechanism, said query reduction mechanism in communication with the short message service center and with the home location register;
providing said query reduction mechanism with the location information relating to a plurality of subscribers to the network;
receiving an incoming message from a subscriber's mobile device at the short message service center;
sending a lookup query from the short message service center to the query reduction mechanism to determine a destination location for sending the incoming message to a destination mobile device;
sending a response to the lookup query from the query reduction mechanism to the short message service center with the destination location for the message; and
delivering the message and the destination location of the message to the mobile switching center for transmission of the message to the destination mobile device.

2. The method in accordance with claim 1, said method comprising the further step of:
periodically updating the location information relating to a plurality of subscribers to the network in the query reduction mechanism with information from a subscriber provisioning system.

3. The method in accordance with claim 1 wherein the query reduction mechanism includes route caching logic and a route cache for storing the address information of the plurality of subscribers, said method comprising the further steps of:
receiving the lookup query from the short message service center at the route caching logic of the query reduction mechanism;
using the route caching logic to query the route cache to determine a destination location for sending the incoming message to a destination mobile device;
if a corresponding cache entry is found, providing the destination location from the route cache to the route caching logic; and
sending a response to the lookup query from the route caching logic to the short message service center with the destination location for the message.

4. The method in accordance with claim 3, said method comprising the further steps of:
if a corresponding cache entry is not found in the route cache for a destination location request,
sending a lookup query from the route caching logic to the home location register to determine a destination location for the incoming message;
receiving a response to the lookup query from the home location register at the route caching logic;
if the response from the home location register includes a destination location for the message; sending a response to the lookup query from the route caching logic to the short message service center with the destination location for the message, or
if the response from the home location register does not include a destination location for the message; sending a response to the lookup query from the route caching logic to the short message service center that the destination location for the message cannot be found.

5. The method in accordance with claim 1, said method comprising the further step of:
time stamping the location information relating to the plurality of subscribers at the time that the location information is provided to the query reduction mechanism;
permitting the location information relating to any subscriber to expire upon the passage of a predetermined amount of time from the time that the location information is provided to the query reduction mechanism; and
updating the location information in query reduction mechanism relating to any subscriber upon receipt of new information that the subscriber's location or status has changed.

6. The method in accordance with claim 1 wherein the query reduction mechanism includes a passive monitor, said method comprising the further steps of:
receiving updated subscriber location information at the passive monitor; and
providing the updated subscriber location information from the passive monitor to the route cache for storage therein.

7. A method for reducing the traffic volume associated with home subscriber server queries used to determine a subscriber's location in an Internet protocol multimedia subsystem network, said network including a short message service center, a home subscriber server and a call session control function, said method comprising the steps of:
providing a query reduction mechanism, said query reduction mechanism in communication with the short message service center and with the home subscriber server;
providing said query reduction mechanism with the location information relating to a plurality of subscribers to the network;
receiving an incoming message from a subscriber's mobile device at the short message service center;
sending a lookup query from the short message service center to the query reduction mechanism to determine a destination location for sending the incoming message to a destination mobile device;
sending a response to the lookup query from the query reduction mechanism to the short message service center with the destination location for the message; and
delivering the message and the destination location of the message to the call session control function for transmission of the message to the destination mobile device.

8. The method in accordance with claim 7, said method comprising the further step of:
periodically updating the location information relating to a plurality of subscribers to the network in the query reduction mechanism with information from a subscriber provisioning system.

9. The method in accordance with claim 7 wherein the query reduction mechanism includes route caching logic and a route cache for storing the address information of the plurality of subscribers, said method comprising the further steps of:
receiving the lookup query from the short message service center at the route caching logic of the query reduction mechanism;
using the route caching logic to query the route cache to determine a destination location for sending the incoming message to a destination mobile device;
if a corresponding cache entry is found, providing the destination location from the route cache to the route caching logic; and
sending a response to the lookup query from the route caching logic to the short message service center with the destination location for the message.

10. The method in accordance with claim 9, said method comprising the further steps of:
if a corresponding cache entry is not found in the route cache for a destination location request, sending a lookup query from the route caching logic to the home subscriber server to determine a destination location for the incoming message;
receiving a response to the lookup query from the home subscriber server at the route caching logic;
if the response from the home subscriber server includes a destination location for the message; sending a response to the lookup query from the route caching logic to the short message service center with the destination location for the message, or
if the response from the home subscriber server does not include a destination location for the message; sending a response to the lookup query from the route caching logic to the short message service center that the destination location for the message cannot be found.

11. The method in accordance with claim 7, said method comprising the further step of:
time stamping the location information relating to the plurality of subscribers at the time that the location information is provided to the query reduction mechanism;
permitting the location information relating to any subscriber to expire upon the passage of a predetermined amount of time from the time that the location information is provided to the query reduction mechanism; and
updating the location information in query reduction mechanism relating to any subscriber upon receipt of new information that the subscriber's location or status has changed.

12. The method in accordance with claim 7 wherein the query reduction mechanism includes a passive monitor, said method comprising the further steps of:
receiving updated subscriber location information at the passive monitor; and
providing the updated subscriber location information from the passive monitor to the route cache for storage therein.

13. A wireless telecommunications network for reducing the traffic volume associated with home location register queries, said network comprising:
a short message service center for receiving an incoming message from a subscriber's mobile device;
a home location register;
a mobile switching center;
a query reduction mechanism, said query reduction mechanism in communication with the short message service center and with the home location register; said query reduction mechanism containing location information relating to a plurality of subscribers to the network;
upon receipt of an incoming message, said short message service center sends a lookup query to the query reduction mechanism to determine a destination location for sending the incoming message to a destination mobile device;
said query reduction mechanism responds to the lookup query by sending the destination location for the message to the short message service center; and
said short message service center delivers the message and the destination location to the mobile switching center for transmission of the message to the destination mobile device.

14. The wireless telecommunications network in accordance with claim 13, said network further comprising:
a subscriber provisioning system for periodically updating the location information in the query reduction mechanism relating to the plurality of subscribers to the network.

15. The wireless telecommunications network in accordance with claim 13, said network further comprising:
route caching logic in the query reduction mechanism; and
a route cache in the query reduction mechanism for storing the address information of the plurality of subscribers; the route caching logic receives the lookup query from the short message service center, and the route caching logic queries the route cache to determine a destination location for sending the incoming message to a destination mobile device;
if a corresponding cache entry is found, the route caching logic provides the destination location from the route cache to the short message service center.

16. The wireless telecommunications network in accordance with claim 15, wherein:
if a corresponding cache entry cannot be found in the route cache, the route caching logic sends a lookup query to the home location register to determine a destination location for the incoming message;
the home location register sends a response to the lookup query to the route caching logic;
if the response from the home location register includes a destination location for the message; the route caching logic sends a response to the short message service center with the destination location for the message, or
if the response from the home location register does not include a destination location for the message; the route caching logic sends a response to the short message service center that the destination location for the message cannot be found.

17. The wireless telecommunications network in accordance with claim 13, wherein:
the location information relating to the plurality of subscribers is time stamped at the time that the location information is provided to the query reduction mechanism;
the location information relating to any subscriber is permitted to expire upon the passage of a predetermined amount of time from the time that the location information is provided to the query reduction mechanism; and
the location information in query reduction mechanism relating to any subscriber is updated upon receipt of new information that the subscriber's location or status has changed.

18. The wireless telecommunications network in accordance with claim 13, said network further comprising:
a passive monitor associated with the query reduction mechanism for receiving updated subscriber location information and for providing the updated subscriber location information from the passive monitor to the route cache for storage therein.

19. An Internet protocol multimedia subsystem network for reducing the traffic volume associated with home subscriber server queries, said network comprising:
a short message service center for receiving an incoming message from a subscriber's mobile device;
a home subscriber server;
a call session control function;
a query reduction mechanism, said query reduction mechanism in communication with the short message service center and with the home subscriber server; said query reduction mechanism containing location information relating to a plurality of subscribers to the network;
upon receipt of an incoming message, said short message service center sends a lookup query to the query reduction mechanism to determine a destination location for sending the incoming message to a destination mobile device;
said query reduction mechanism responds to the lookup query by sending the destination location for the message to the short message service center; and
said short message service center delivers the message and the destination location to the call session control function for transmission of the message to the destination mobile device.

20. The multimedia subsystem network in accordance with claim 19, said network further comprising:
a subscriber provisioning system for periodically updating the location information in the query reduction mechanism relating to the plurality of subscribers to the network.

21. The multimedia subsystem network in accordance with claim 19, said network further comprising:
route caching logic in the query reduction mechanism; and
a route cache in the query reduction mechanism for storing the address information of the plurality of subscribers; the route caching logic receives the lookup query from the short message service center, and the route caching logic queries the route cache to determine a destination location for sending the incoming message to a destination mobile device;
if a corresponding cache entry is found, the route caching logic provides the destination location from the route cache to the short message service center.

22. The multimedia subsystem network in accordance with claim 21, wherein:
if a corresponding cache entry cannot be found in the route cache, the route caching logic sends a lookup query to the home subscriber server to determine a destination location for the incoming message;
the home subscriber server sends a response to the lookup query to the route caching logic;
if the response from the home subscriber server includes a destination location for the message; the route caching logic sends a response to the short message service center with the destination location for the message, or
if the response from the home subscriber server does not include a destination location for the message; the route caching logic sends a response to the short message service center that the destination location for the message cannot be found.

23. The multimedia subsystem network in accordance with claim 19, wherein:
the location information relating to the plurality of subscribers is time stamped at the time that the location information is provided to the query reduction mechanism;
the location information relating to any subscriber is permitted to expire upon the passage of a predetermined amount of time from the time that the location information is provided to the query reduction mechanism; and
the location information in query reduction mechanism relating to any subscriber is updated upon receipt of new information that the subscriber's location or status has changed.

24. The multimedia subsystem network in accordance with claim 19, said network further comprising:
a passive monitor associated with the query reduction mechanism for receiving updated subscriber location information and for providing the updated subscriber location information from the passive monitor to the route cache for storage therein.
